(19) United States
(12) Patent Application Publication
(10) Pub. No.: US 2009/0290021 A1
(43) Pub. Date: Nov. 26, 2009

(54) REAR SEAT PASSENGER SURVEILLANCE SYSTEM

(76) Inventors: Della J. Rudesill, Painesville, OH (US); John R. Rudesill, Painesville, OH (US)

Correspondence Address: GLOBAL PATENTS/RANDY W. TUNG, ESQ, 838 W. LONG LAKE, SUITE 120, BLOOMFIELD HILLS, MI, 48302, US

(21) Appl. No.: 12/126,516

(22) Filed: May 23, 2008

(51) Int. Cl. H04N 7/18

(52) U.S. Cl. 348/148; 348/E07.085

(57) ABSTRACT

A rear seat passenger surveillance camera/display system is constructed of an automobile that has a dashboard, a rear seat and a headliner panel; a video camera mounted on the headline panel at a substantially central location with a lens of the camera pointing downwardly; a video display panel mounted on the dashboard for receiving signals from the video camera, displaying an image of the rear seat, and for viewing by the automobile operator; and wiring for supplying electric power to the video camera and the video display panel from a power source in the automobile.

### FIELD OF THE INVENTION

The present invention generally relates to an automobile accessory and more particularly, relates to a surveillance camera and display system for rear seat passengers in an automobile.

### BACKGROUND OF THE INVENTION

When a family travels in an automobile, young children or babies are normally required to be seated in the rear seat of the automobile. The young children or babies may be strapped down in a child seat or a baby seat and then the seat fastened by seat belt to the rear seat. When the family travels with someone who may be an invalid or a person that is mentally challenged, the person may also be seated in the rear seat. A driver of the automobile needs to frequently turn around to check on the conditions or the child or the invalid person which may present a safety hazard when his attention is diverted from the road ahead in the direction that the vehicle is moving. This situation not only endangers the automobile occupants but also may endanger other vehicles that are traveling on the road. It is therefore desirable to provide a method for surveillance of the rear seat passengers without having to turn around and check the conditions of the rear seat passengers.

It is therefore an object of the present invention to provide a surveillance camera and a display system mounted on the dashboard for monitoring the conditions of rear seat passengers.

### SUMMARY OF THE INVENTION

In accordance with the present invention, a rear seat passenger surveillance camera and a display system is provided.

In a preferred embodiment, the present invention rear seat passenger surveillance camera and display system for use in an automobile can be provided by an automobile that has a dashboard, a rear seat and a headliner panel; a video camera mounted on the headline panel at a substantially central location with a lens of the camera pointing downwardly; a video display panel mounted on the dashboard for receiving signals from the video camera, displaying an image of the rear seat, and for viewing by the automobile operator; and wiring for supplying electric power to the video camera and the video display panel from a power source in the automobile.

### BRIEF DESCRIPTION OF THE DRAWINGS

The invention will now be described, by way of example, with reference to the accompanying drawings, in which.

FIG. 1 is a plan view of the present invention surveillance camera and display system.

FIG. 2 is a plan view of the present invention surveillance camera and display system as mounted in an automobile.

FIG. 3 is a partial, exploded view of the front passenger compartment of the automobile equipped with the display system.

FIG. 4 is a block functional diagram of the present invention rear seat passenger surveillance system.

### DETAILED DESCRIPTION OF THE PREFERRED EMBODIMENT

The present invention discloses a rear seat passenger surveillance camera and display system for use in an automobile.

The present invention rear seat passenger surveillance camera and display system is a video monitoring system for automobiles that enables the driver to see infants, children, or special needs individuals in the backseat without turning around. The present invention rear seat passenger surveillance camera and display system can be offered as an optional feature on minivans, SUV's, or other family vehicles.

The present invention rear seat passenger surveillance camera and display system consists of a miniature video camera mounted in the rear of the vehicle so it will point toward the back seat (where babies and young children are normally seated). The component of the system will be 2 to 4 inch monitor screen built-into or positioned on the dashboard of the vehicle. Both components of the present invention will be AC/DC powered and removable, making it possible to remove the monitoring system from the vehicle and use it in the home, if desired. Variations of the present invention could include positioning the camera in different directions or locations in the vehicle, or positioning the monitoring along the sun visor. The monitor will fold flat when not in use and as mentioned above, will be removable. The camera allows a parent or another adult driver to maintain visual contact with the young child or a baby in the backseat. The driver will be able to check the baby in the monitor without stopping the vehicle or turning around. With the vehicle in motion, these brief monitor checks will be much safer than attempting to turn the head or body to check the child.

The present invention surveillance camera and display system fulfills the need for a safe way to keep an eye on children (or others) in the back seat of a moving vehicle. The appealing features of the present invention are its increased safety and use for families who travel with children in the rear seats of passenger vehicles. For babies, toddlers, and young children, the recommended seating position for riding in the vehicle is the back seat. This position is by far the safest for the child, but unfortunately makes it difficult and unsafe for a driver to visually check the baby, especially while the vehicle is in motion. Turning one's head and craning to view or reach into the backseat is both an uncomfortable and potentially extremely dangerous maneuver for the driver, yet pulling over to frequently check the child is inconvenient and completely unnecessary. The video monitoring system can be offered in virtually any type of passenger vehicle, allowing a parent or another adult to check the choir frequently without turning around. The driver will be able to maintain visual contact by simply glancing in the monitor and can continue safe and attentive driving while assuring him- or herself of the baby's safety. The present invention is particularly useful for parents or newborns or infants in rear-facing car seats. The little one can be particularly difficult to monitor, and they may also need it the most. Premature or sick infants, especially those who can't support their heads, may experience occasional breathing difficulties. Parents must watch them closely and make sure their heads are properly positioned. With rear-facing car seats, this can be extremely difficult. The present invention is effective and safe for parents who must keep a close eye on their infants in rear-facing seats. The present invention can be extremely versatile. It will be AC/DC powered and can be removed from the vehicle for use in the home (or elsewhere). The present invention can be marked to police forces, emergency response EMT serves, and taxicab companies.

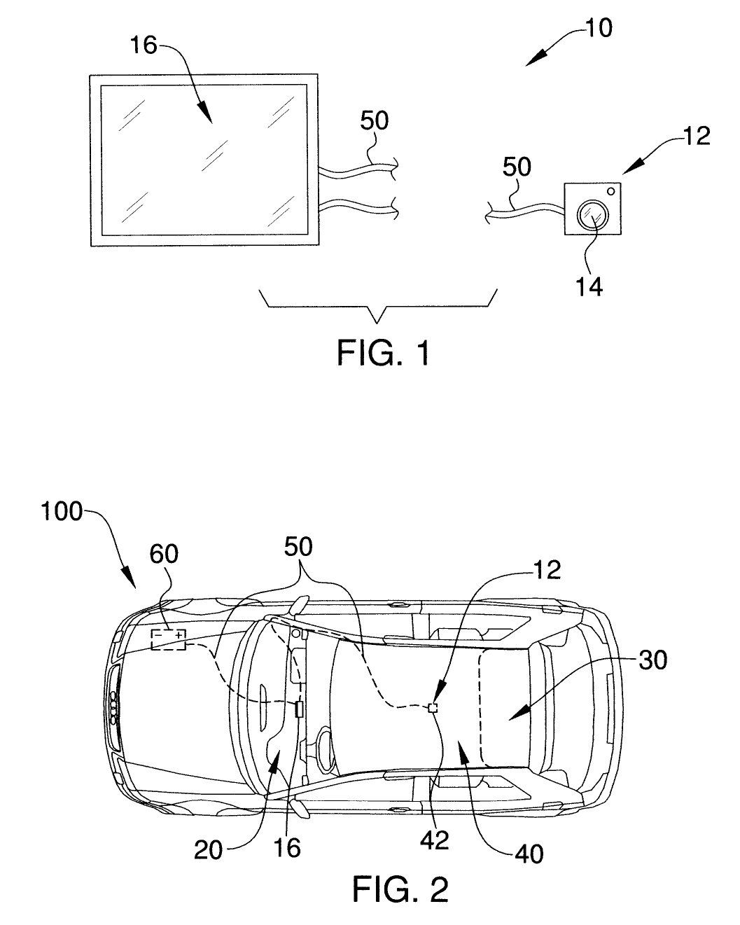

Referring initially to FIG. 1, wherein a present invention rear seat passenger surveillance camera and display system 10 is shown in a plan view. The surveillance camera/display system 10 is mounted in an automobile 100, shown in FIG. 2, which has a dashboard 20, a rear seat 30 and a headliner panel 40. A video camera 12 mounted on the headliner 40 at a substantially central location 42 with a lens 14 pointing downwardly.

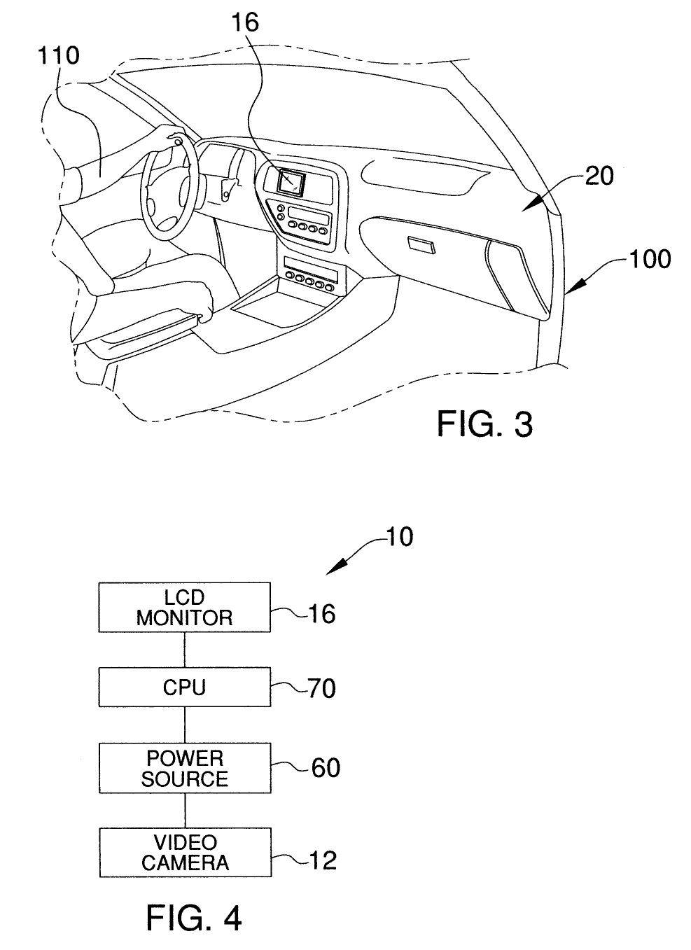

A video display panel 16 is mounted on the dashboard 20, shown in FIGS. 2 and 3, for receiving signals from the video camera 12, displaying an image of the rear seat 30 and its occupants (not shown), and for viewing by the automobile operator 110. The present invention rear seat passenger surveillance camera/display system 10 further includes wiring 50 for supplying electric power to the video camera 12 and the video display panel 16 from a power source 60, such as the battery, in the automobile 100. A central processing unit 70, as shown in FIG. 4, is further included either as part of the video camera 12 or as part of the display system 16. A functional block diagram for the present invention surveillance camera/display system 10 is further shown in FIG. 4.

The present invention rear seat passenger surveillance camera/display system has therefore been amply described in the above descriptions and in the appended drawings of FIGS. 1-4.

While the preferred embodiments of the invention have been described above, it will be recognized and understood that various modifications can be made in the invention and the appended claims are intended to cover all such modifications which may fall within the spirit and scope of the invention.

What is claimed is:

1. A surveillance camera display system for rear seat passengers in an automobile comprising:
an automobile having a dashboard, a rear seat and a headliner panel;
a video camera mounted on said headliner panel at a substantially central location with a lens of said camera pointing downwardly;
a video display panel mounted on said dashboard for receiving signals from said video camera, displaying an image of said rear seat, and for viewing by said automobile operator; and
wiring for supplying electric power to said video camera and said video display panel from a power source in said automobile.

2. The surveillance camera/display system for rear seat passengers according to claim 1 further comprising a central processing unit attached to said display panel.

3. The surveillance camera/display system for rear seat passengers according to claim 1 further comprising a central processing unit attached to the video camera.

4. The surveillance camera/display system for rear seat passengers according to claim 1, wherein said video camera is equipped with a wide-angle lens.

5. The surveillance camera/display system for rear seat passengers according to claim 1 further comprising wiring between said video camera and said video display panel.

6. The surveillance camera/display system for rear seat passengers according to claim 1, wherein said video display panel is removably mounted to the dashboard by a hook-and-loop fastener system.
